(19) United States
(12) Patent Application Publication
(10) Pub. No.: US 2015/0324873 A1
(43) Pub. Date: Nov. 12, 2015

(54) SYSTEM AND METHOD FOR AUTOMATICALLY TRANSITIONING CUSTOMERS FROM ONE SERVICE TO ANOTHER SERVICE

(71) Applicant: Factor Systems, Inc., Hamilton, NJ (US)

(72) Inventors: James Eichmann, Hamilton, NJ (US); Bruno Perreault, Hamilton, NJ (US); Flint Lane, Hamilton, NJ (US); Thomas Bartolucci, Hamilton, NJ (US)

(73) Assignee: Factor Systems, Inc., Hamilton, NJ (US)

(21) Appl. No.: 14/274,214

(22) Filed: May 9, 2014

(51) Int. Cl. G06Q 30/04; G06Q 20/14; G06Q 30/02

(52) U.S. Cl. CPC G06Q 30/04; G06Q 30/0281; G06Q 20/14

(57) ABSTRACT

An instruction is transmitted from an end user to a first customer. The instruction indicates that end user desires to receive correspondences in a first format. A message is transmitted from the first customer to a data-processing system. The data-processing system updates its memory such that first customer is now subscribed to a service for sending correspondences to the end user in the first format. Additionally, the data-processing system automatically and dynamically performs a determination to establish whether the end user is associated with other customers. Based on the determination, a message is transmitted to a second customer in an attempt to transition the second customer from one service to another service. In response, the data-processing system receives a message from the second customer and updates its memory such that second customer is now subscribed to the service for sending correspondences to the end user in the first format.

### FIELD OF THE INVENTION

The present invention relates to a system and method for automatically and dynamically transitioning customers from one service to another service.

### BACKGROUND OF THE INVENTION

In a subscription-based business model, end users are consumers that subscribe to a service offered by a service provider. For example, an end user can be a household, a government agency, a medical practice, etc. These end users typically have a subscription-based relationship with one or more service providers that deliver Internet, telephony, television, etc., services. The subscription-based relationship between end users and the service providers is usually on a periodic basis. At the end of each month or quarterly, for example, an invoice is either courier mailed, faxed, or e-mailed directly from each service provider to the end user.

Different end users may have different criteria for receiving invoices from their service providers. As an example, one end user may prefer to receive invoices via courier mail, while another end user may prefer to receive invoices via e-mail. However, a scenario may arise where an end user desires to change the method by which the end user receives invoices; for example, via e-mail instead of courier mail.

Because it is not uncommon for an end user to have an on-going, subscription-based relationship with a number of service providers, this end user would need to separately contact each service provider to notify them of his/her desire to switch from one form of media to another form of media for receiving invoices. Therefore, the number of contacts the end user must initiate to make the switch is proportional to the number of service providers in which the end user has a relationship with.

As one can see, this scenario can become quite overwhelming and time consuming if an end user has an on-going relationship with tens or hundreds of service providers.

### SUMMARY OF THE INVENTION

The present invention provides a third-party invoicing and/or disbursement service that cures some of the deficiencies of the prior art discussed above. The third-party of the present invention may have one or more customers that are subscribed to the invoicing and/or disbursement services. The customers can be, for example, and without limitation, one or more service providers.

In accordance with the illustrative embodiment, an instruction is transmitted from an end user to a first customer through a network. The instruction notifies the first customer that the end user desires to receive correspondences from the first customer in a first format.

Upon receiving the instruction, the first customer transmits a first message to a data-processing system of the third-party. The data-processing system receives the first message and performs the necessary tasks to update its memory to reflect the end user's desire. From this point on, when the third-party's data-processing system receives a correspondence from the first customer that is addressed to the end user, the data-processing system will know to send the correspondence to the end user in the first format.

It will be clear to those skilled in the art, after reading this disclosure, how to make and use alternative embodiments of the present invention in which the instruction can be transmitted directly from the end user to the data-processing system, thus bypassing the need to transmit the instruction to the first customer.

In both embodiments, the third-party's data-processing system initiates a determination upon receiving the first message or the instruction. The determination is to establish whether the end user is associated with a second customer. In the illustrative embodiment, this determination is performed automatically by the data-processing system without receiving any instructions to do so from the first customer and the end user.

If the determination is in the affirmative, the third-party's data-processing system transmits a second message to a second customer. The second message notifies the second customer that the end user is interested in receiving correspondences in the first format. The second message also notifies the second customer that a service is provided by the third-party for satisfying the end user's desire to receive correspondences in the first format.

After receiving the second message from the third-party's data-processing system, the second customer has the option of declining or subscribing to the service. If subscription to the service is in the affirmative, the second customer transmits a third message to the data-processing system.

Receipt of the third message causes the third-party's data-processing system to update its memory in a similar fashion discussed above, with respect to the first message. From this point on, when the data-processing system receives a correspondence from the second customer that is addressed to the end user, the data-processing system will know to send the correspondence to the end user in the first format.

### BRIEF DESCRIPTION OF THE DRAWINGS

FIG. 1 depicts a schematic diagram of system 100 in accordance with the illustrative embodiment of the present invention.

FIG. 2 depicts the salient components of end user terminal 104-1 in accordance with the illustrative embodiment of the present invention.

FIG. 3 depicts the salient components of first customer 108-1 in accordance with the illustrative embodiment of the present invention.

FIG. 4 depicts the salient components of third-party data-processing system 112 in accordance with the illustrative embodiment of the present invention.

FIG. 5 depicts a flowchart of the salient tasks performed by the illustrative embodiment for automatically transitioning customers from one service to another service.

FIG. 6 depicts a flowchart of the salient tasks performed by the illustrative embodiment in accomplishing task 504.

FIG. 7 depicts a flowchart of the salient tasks performed by the illustrative embodiment in accomplishing tasks 506 and 508.

FIG. 8 depicts a flowchart of the salient task performed by the illustrative embodiment in accomplishing task 518.

FIG. 9 depicts a graphical user interface (GUI) in accordance with an illustrative embodiment of the present invention.

FIG. 10 depicts a flowchart of the salient tasks performed by an alternative embodiment of the present invention.

### DETAILED DESCRIPTION

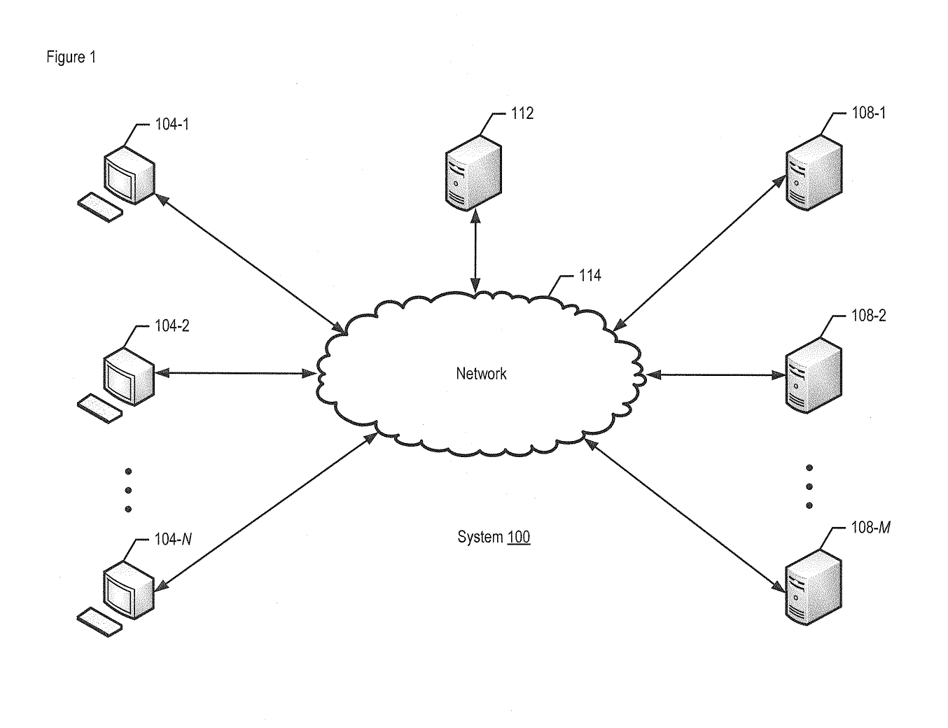

FIG. 1 depicts a schematic diagram of system 100 in accordance with the illustrative embodiment of the present invention. System 100 comprises: end user terminals 104-1 through 104-N; customer data-processing systems 108-1 through 108-M; third-party data-processing system 112; and network 114.

As discussed in the beginning of this disclosure, the present invention provides a third-party invoicing and/or disbursement service. The third-party may have one or more customers that are subscribed to the invoicing and/or disbursement services. The customers can be, for example, and without limitation, one or more service providers.

The “customers” may have one or more data-processing systems 108. For the purpose of this disclosure, the nomenclature of “first customer,” “second customer,” etc., will be used when referring to customer data-processing systems 108.

It will be clear to those skilled in the art, after reading this disclosure, how to make and use alternative embodiments of the present invention in which system 100 may comprise any number of end user terminals, data-processing systems, and networks.

Furthermore, it will be clear those skilled in the art, after reading this disclosure, how to make and use alternative embodiments of the present invention in which system 100 may comprise additional elements not depicted in FIG. 1. For example, and without limitation, system 100 may comprise one or more gateway servers, proxy servers, routers, switches, bridges, firewalls, databases, etc.

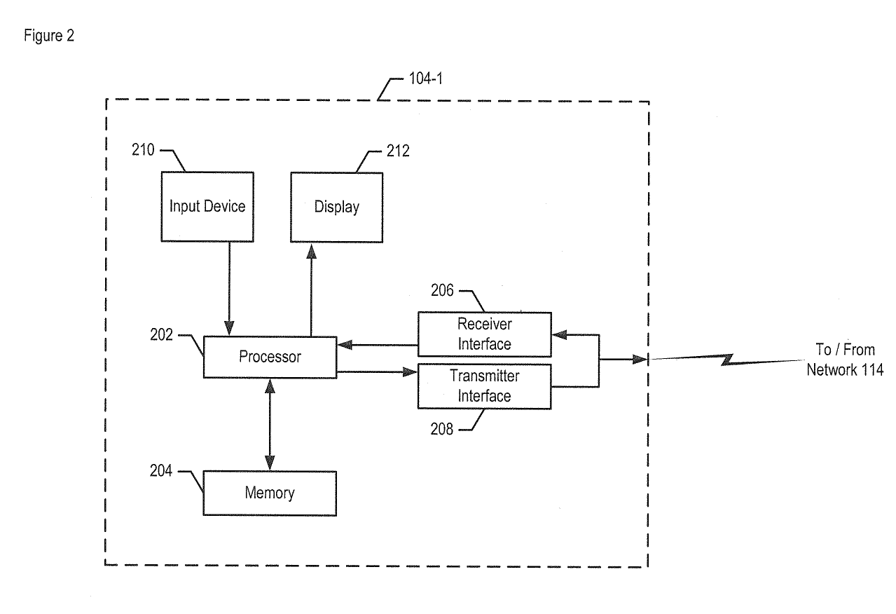

FIG. 2 depicts the salient components of end user terminal 104-1 in accordance with the illustrative embodiment of the present invention. End user terminal 104-1 comprises: processor 202; memory 204; receiver interface 206; transmitter interface 208; input device 210; and display 212.

Processor 202 can be a general or special purpose processor, and memory 204 can be random access memory (RAM), read-only memory (ROM), dynamic random-access memory (DRAM), or any combination thereof.

Memory 204 is configured to store one or more computer-readable instructions which, when executed by processor 202, enables terminal 104-1 to transmit an instruction to first customer 108-1, second customer 108-2, and so forth. For example, and in accordance with the illustrative embodiment, an end user may operate input device 210 of terminal 104-1 to transmit an instruction. The instruction is transmitted via transmitter interface 208 through network 114 to first customer 108-1.

It will be clear to those skilled in the art, after reading this disclosure, how to make and use alternative embodiments of the present invention in which the tasks performed by terminal 104-1 can likewise be performed by terminals 104-2 through 104-N. The tasks performed by terminal 104-1 will be described in more detail below.

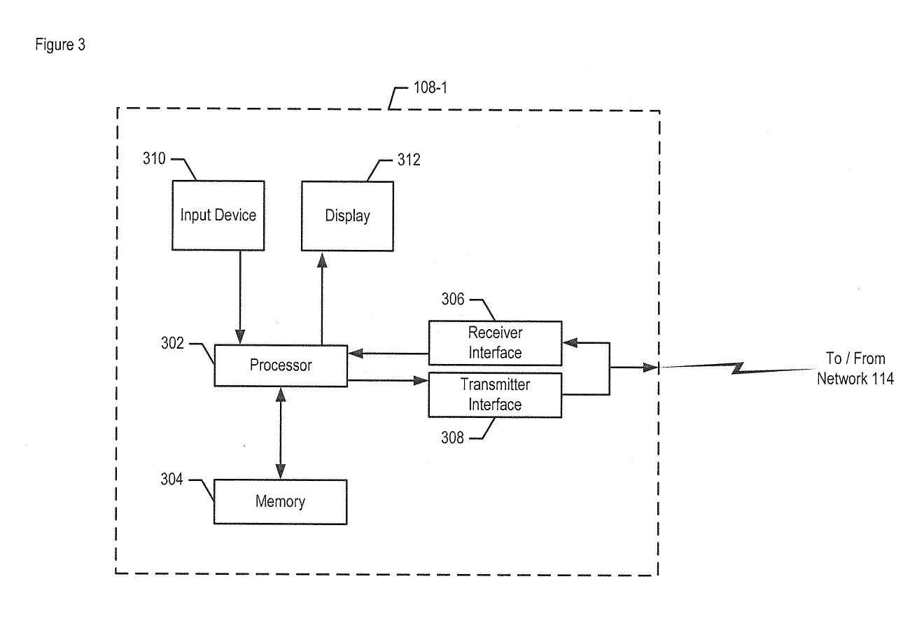

FIG. 3 depicts the salient components of first customer 108-1 in accordance with the illustrative embodiment of the present invention. First customer 108-1 comprises: processor 302; memory 304; receiver interface 306; transmitter interface 308; input device 310; and display 312.

Processor 302 can be a general or special purpose processor, and memory 304 can be random access memory (RAM), read-only memory (ROM), dynamic random-access memory (DRAM), or any combination thereof.

First customer 108-1 is configured to receive an instruction from end user terminal 104-1. The instruction is received via receiver interface 306, which is then processed by processor 302. Thereafter, processor 302 is further configured to execute one or more computer readable instructions stored in memory 304 to transmit a message (i.e., a “first message”) to third-party data-processing system 112.

It will be clear to those skilled in the art, after reading this disclosure, how to make and use alternative embodiments of the present invention in which the tasks performed by first customer 108-1 can likewise be performed by customers 108-2 through 108-M. The tasks performed by first customer 108-1 will be described in more detail below.

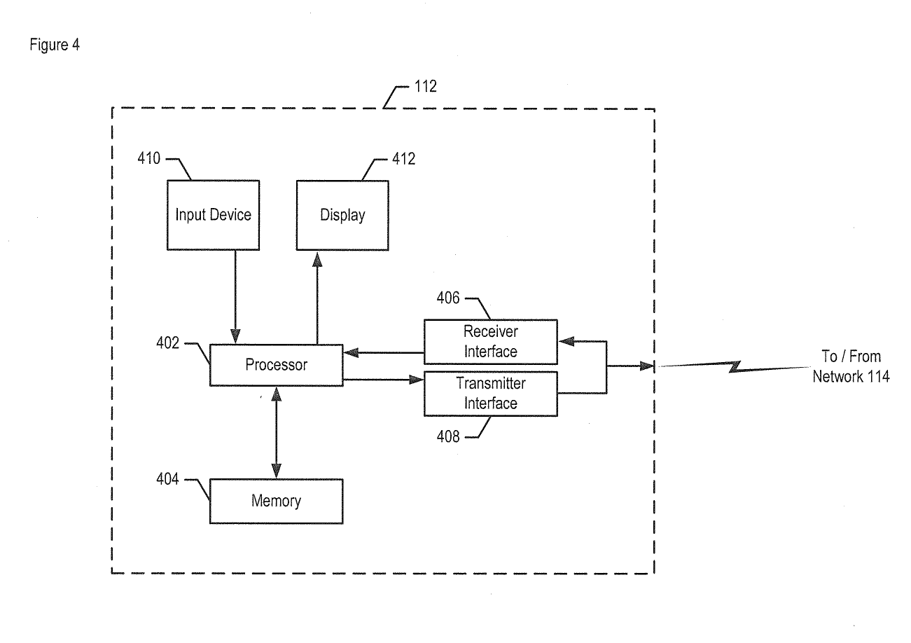

FIG. 4 depicts the salient components of third-party data-processing system 112 in accordance with the illustrative embodiment of the present invention. Data-processing system 112 comprises: processor 402; memory 404; receiver interface 406; transmitter interface 408; input device 410; and display 412.

Processor 402 can be a general or special purpose processor, and memory 404 can be random access memory (RAM), read-only memory (ROM), dynamic random-access memory (DRAM), or any combination thereof.

Data-processing system 112 is configured to receive the message (i.e., the “first message”) from first customer 108-1. The message is received via receiver interface 406, which is then processed by processor 402. In accordance with the illustrative embodiment, the message notifies data-processing system 112 that the end user of terminal 104-1 desires to receive correspondences in a first format.

In response to receiving the message, data-processing system 112 executes one or more computer-readable instructions stored in memory 404. Executing the computer-readable instructions updates memory 404 to reflect the end user's desire to switch from one form of media to another form of media for receiving correspondences. From this point on, when data-processing system 112 receives a correspondence from first customer 108-1 that is addressed to the end user of terminal 104-1, data-processing system 112 will know to send the correspondence to the end user in the first format.

In addition, processor 402 executes one or more computer-readable instructions stored in memory 404 to determine whether the end user of terminal 104-1 is associated with another customer, such as second customer 108-2. Based on this determination, data-processing system 112 is able to transition customers from one service to another service. In accordance with the illustrative embodiment, the determination is performed automatically by data-processing system 112 without receiving any instructions to do so from first customer 104-1 and the end user of terminal 104-1. The tasks performed by data-processing system 112 will be described in more detail below.

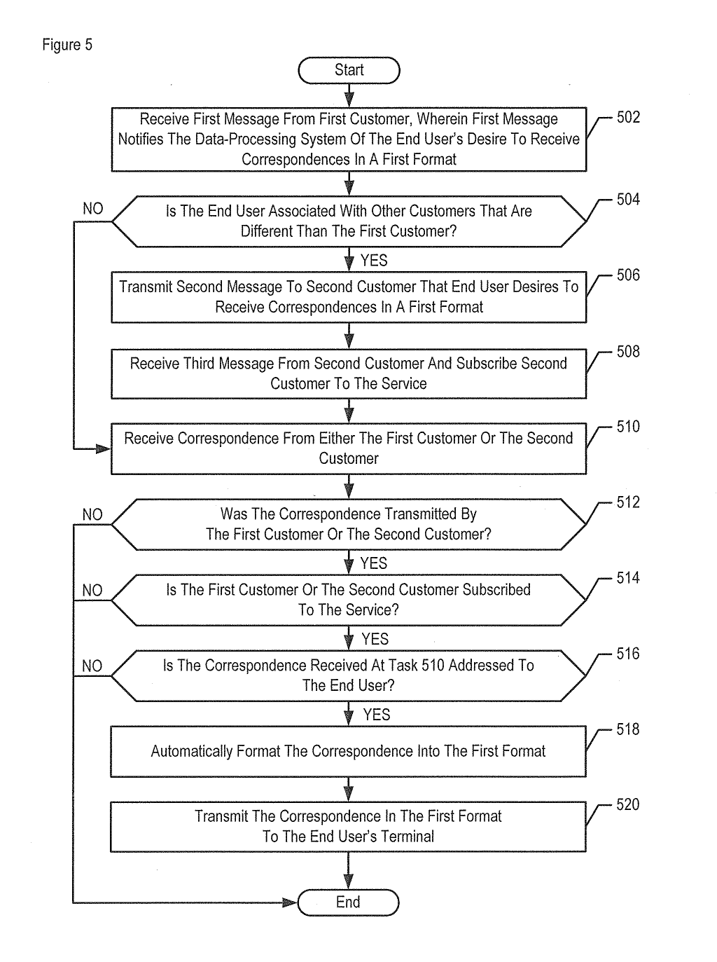

FIG. 5 depicts a flowchart of the salient tasks performed by the illustrative embodiment for automatically transitioning customers from one service to another service.

It will be clear to those skilled in the art, after reading this disclosure, how to make and use alternative embodiments of the present invention in which task 502 through task 520 can be performed in any order without departing from the scope of the invention.

Furthermore, it will be clear to those skilled in the art, after reading this disclosure, how to make and use alternative embodiments of the present invention in which FIG. 5 can include more or less tasks than depicted.

At task 502, third-party data-processing system 112 receives a message (i.e., a “first message”) from first customer 108-1 via receiver interface 406. The first message notifies data-processing system 112 that the end user of terminal 104-1 desires to receive correspondences in a first format. The correspondence can be, for example, and without limitation, invoices, notifications, advertisements, coupons, promotions, etc.

In response to receiving the first message, data-processing system 112 updates memory 404 such that first customer 108-1 is now subscribed to the service for sending correspondences to the end user in the first format. From this point on, when the data-processing system 112 receives a correspondence from first customer 108-1 that is addressed to the end user of terminal 104-1, data-processing system 112 will know to send the correspondence to the end user in the first format.

At task 504, third-party data-processing system 112 performs a determination (i.e., a “first determination”). Specifically, the first determination is performed to establish whether the end user of terminal 104-1 is associated with another customer, such as second customer 108-2. In accordance with the illustrative embodiment, data-processing system 112 automatically and dynamically performs the first determination without receiving any instructions to do so from first customer 108-1 and the end user of terminal 104-1.

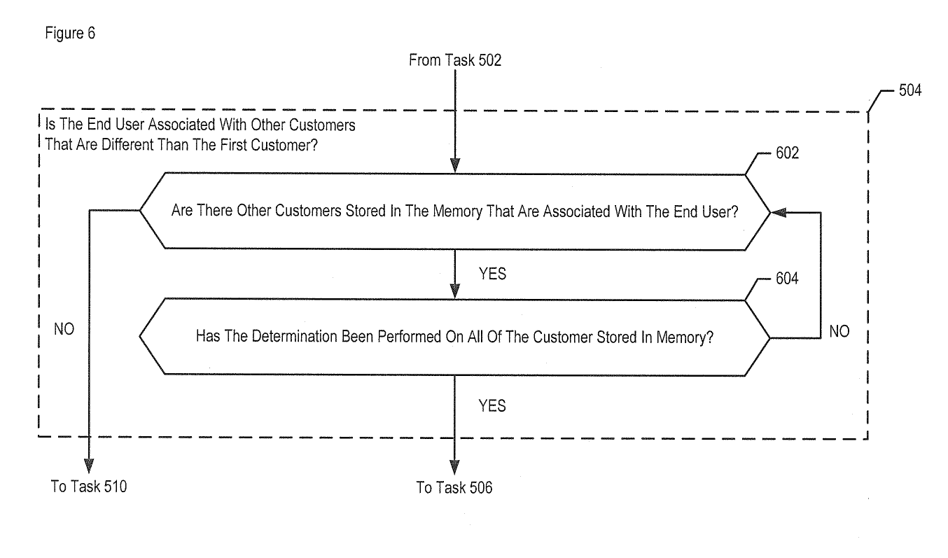

If data-processing system 112 determines from task 504 that the end user of terminal 104-1 is not associated with any other customers, then the flow moves to task 510. On the other hand, if the determination reveals that there are other customers associated with the end user of terminal 104-1, then the flow moves to task 506. Task 504 will be described in more detail below, with respect to FIG. 6.

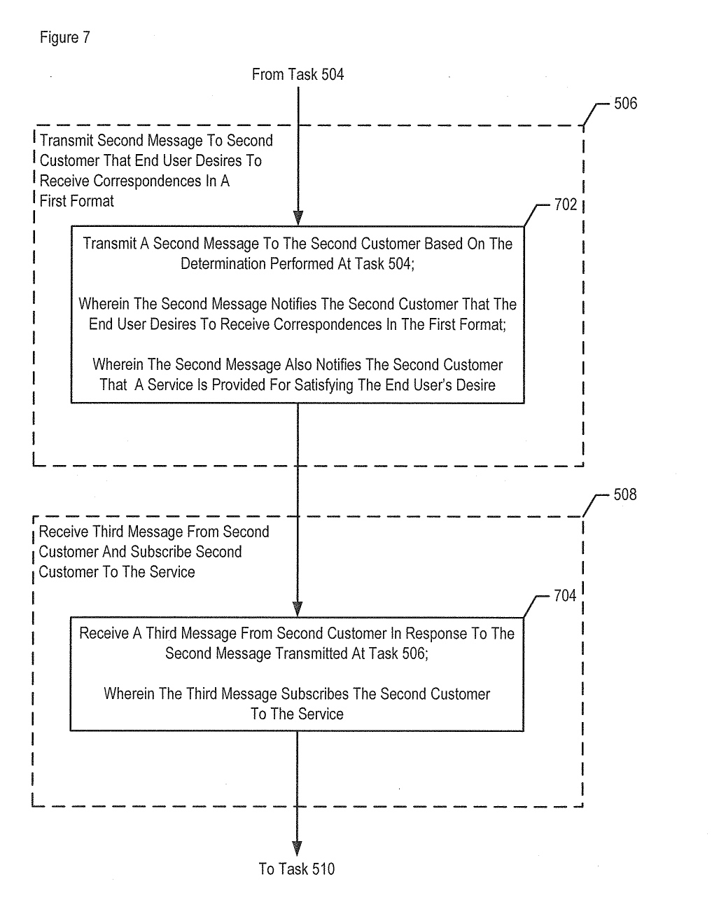

At task 506, third-party data-processing system 112 transmits a message (i.e., a “second message”) to second customer 108-2 based on the determination performed at task 504. The second message notifies second customer 108-2 that the end user of terminal 104-1 is interested in receiving correspondences in the first format. The second message also notifies second customer 108-2 that a service is provided by the third-party for satisfying the end user's desire to receive correspondences in the first format. Task 506 will be described in more detail below, with respect to FIG. 7.

At task 508, third-party data-processing system 112 receives a message (i.e., a “third message”) from second customer 108-2. Receipt of the third message causes data-processing system 112 to update memory 404 in a similar fashion discussed above, with respect to task 502. From this point on, when data-processing system 112 receives a correspondence from second customer 108-2 that is addressed to the end user of terminal 104-1, data-processing system 112 will know to send the correspondence to the end user in the first format. Task 508 will be described in more detail below, with respect to FIG. 7.

At task 510, third-party data-processing system 112 is in a stand-by mode for receiving correspondences. At some point in time, data-processing system 112 receives a correspondence from a customer 108. Upon receiving the correspondence, data-processing system 112 queries memory 404 to perform a series of determinations, as will be described below with respect to task 512 through task 516.

At task 512, third-party data-processing system 112 determines if the correspondence received at task 510 is from the first customer 108-1 or the second customer 108-2. If the correspondence is received from an entity other than the first customer 108-1 and the second customer 108-2, the flow ends. On the other hand, if the determination is in the affirmative, the flow moves to task 514.

At task 514, third-party data-processing system 112 determines if first customer 108-1 or second customer 108-2 is subscribed to the service for sending correspondences to the end user of terminal 104-1 in the first format. If the first and second customers are not subscribed to the service, the flow ends. On the other hand, if the determination is in the affirmative, the flow moves to task 516.

At task 516, third-party data-processing system 112 determines if the correspondence is addressed to the end user of terminal 104-1. If the correspondence is not addressed to the end user of terminal 104-1, the flow ends. On the other hand, if the determination is in the affirmative, the flow moves to task 518.

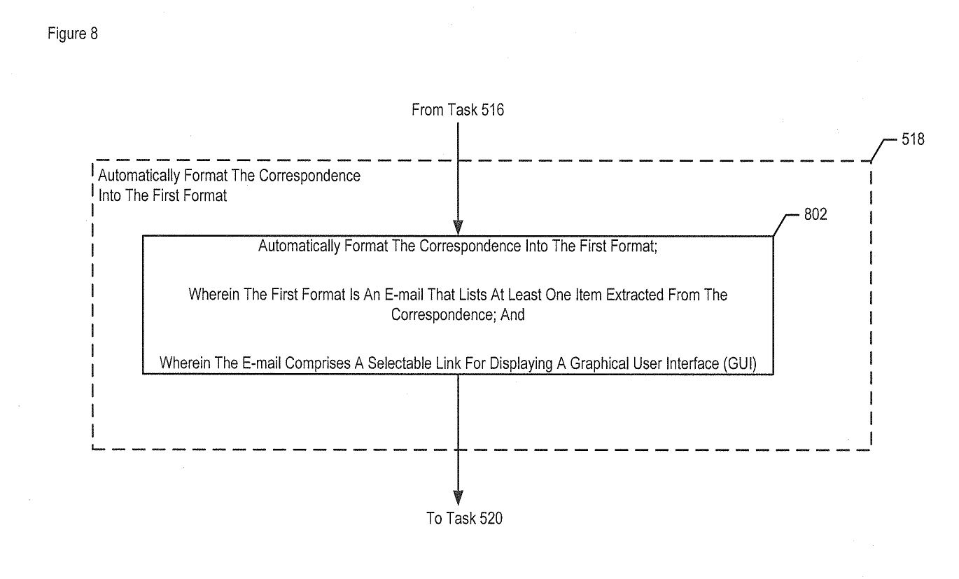

At task 518, third-party data-processing system 112 formats the correspondence into the first format after the determinations performed at task 512 through task 516 are in the affirmative. Task 518 will be described in more detail below, with respect to FIG. 8.

At task 520, third-party data-processing system 112 transmits the correspondence in the first format to the end user of terminal 104-1. Once the correspondence has been transmitted to the end user in the first format, the flow ends.

It will be clear to those skilled in the art, after reading this disclosure, how to make and use alternative embodiments of the present invention in which data-processing system 112 is configured to perform task 502 through task 520 for any number of end users and customers or a combination thereof.

FIG. 6 depicts a flowchart of the salient tasks performed by the illustrative embodiment in accomplishing task 504.

At task 602, third-party data-processing system 112 performs a first determination to establish whether the end user of terminal 104-1 is associated with another customer that is different from first customer 108-1. If data-processing system 112 determines that the end user is not associated with another customer, then the flow moves to task 510, where data-processing system 112 enters a stand-by mode for receiving correspondences. On the other hand, if data-processing system 112 determines that the end user is associated with another customer, then the flow moves to task 604.

At task 604, third-party data-processing system 112 determines if task 602 has been performed on all of the customers stored in memory 404. If data-processing system 112 determines that there are more customers, then the flow moves back to task 602. On the other hand, if data-processing system 112 determines that task 602 has been performed on all of the customers stored in memory 404, then the flow moves to task 506.

FIG. 7 depicts a flowchart of the salient tasks performed by the illustrative embodiment in accomplishing task 506 and task 508.

At task 702, third-party data-processing system 112 transmits a second message to second customer 108-2 based on the first determination performed at task 504. As discussed above, the second message notifies second customer 108-2 that the end user of terminal 104-1 is interested in receiving correspondences in the first format. The second message also notifies second customer 108-2 that a service is provided by the third-party for satisfying the end user's desire to receive correspondences in the first format.

At task 704, third-party data-processing system 112 receives a third message from second customer 108-2. Receipt of the third message causes data-processing system 112 to update memory 404 such that second customer 108-2 is now subscribed to the service for sending correspondences to the end user in the first format. From this point on, when the data-processing system 112 receives a correspondence from second customer 108-2 that is addressed to the end user of terminal 104-1, data-processing system 112 will know to send the correspondence to the end user in the first format.

FIG. 8 depicts a flowchart of the salient task performed by the illustrative embodiment in accomplishing task 518.

As discussed above, third-party data-processing system 112 enters a stand-by mode for receiving correspondences from customers 108. When data-processing system 112 receives a correspondence, it performs a series of determinations at tasks 512-516 to establish:
(i) whether the correspondence is from the first customer 108-1 or the second customer 108-2;
(ii) whether the first customer 108-1 or the second customer 108-2 is subscribed to the service for sending correspondences to the end user of terminal 104-1 in the first format; and
(iii) whether the correspondence is addressed to the end user of terminal 104-1.

When the determinations performed are in the affirmative, data-processing system 112 automatically formats the correspondence into the first format, which is subsequently transmitted to the end user of terminal 104-1.

In accordance with the illustrative embodiment, the correspondence is an invoice and the first format is an e-mail. Data-processing system 112 automatically formats the invoice into an e-mail by extracting one or more items from the fields of the invoice. The items extracted from the invoice can be, for example, and without limitation, an account number, an invoice number, an invoice date, a due date, an amount due, etc.

Once extracted, the items are formatted into an e-mail that comprises a user selectable link. The link can be invoked by the end user of terminal 104-1 to display a graphical user interface (GUI) on display 212.

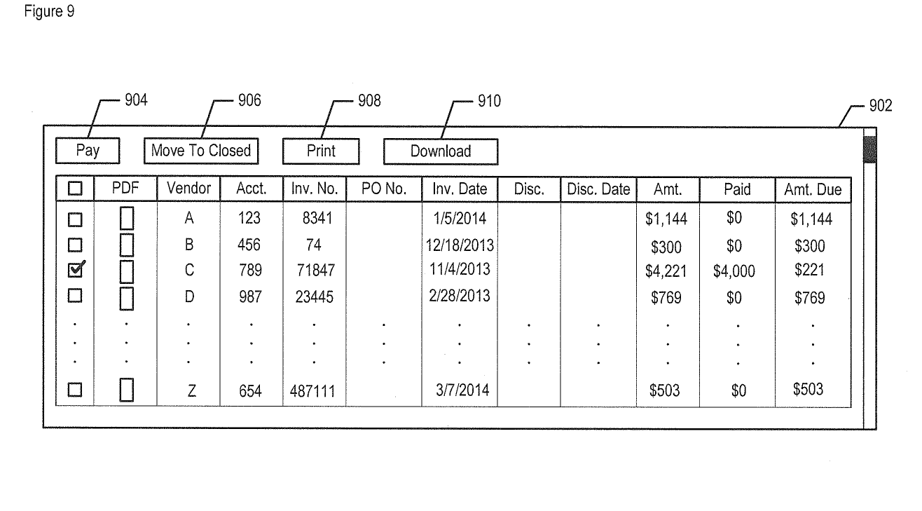

FIG. 9 depicts a graphical user interface (GUI) in accordance with an illustrative embodiment of the present invention.

As discussed above, the end user of terminal 104-1 receives an e-mail from data processing system 112 that comprises a user selectable link. Invoking the link by means of input device 210 displays GUI 902. The GUI comprises, for example, and without limitation, pay button 904, move to closed button 906, print button 908, and download button 910.

GUI 902 also provides information extracted from a plurality of invoices received by data-processing system 112. For example, and without limitation, the information conveyed through GUI 902 includes the vendor that issued the invoice, account number, invoice number, invoice date, description for the services rendered, the date in which the description was entered, the amount due, the amount paid to date, the balance due, etc.

As depicted in FIG. 9, the end user of terminal 104-1 has selected a particular checkbox displayed in GUI 902. Once selected, the end user of terminal 104-1 can invoke one of the buttons 904-910 to perform an action for the selected checkbox.

Invoking button 904 enables the end user of terminal 104-1 to electronically submit a payment for the amount due. Invoking button 906 enables the end user to move a paid invoice to a directory of memory 204 or 404. Invoking button 908 enables the end user to print the selected invoice via a printer or a fax machine. And invoking button 910 enables the end user to download the selected invoice to memory 204.

Although FIG. 9 only depicts that one checkbox is selected by the end user, it will be clear to those skilled in the art that the end user can select a plurality of checkboxes to simultaneously pay, move to closed, print, and download the invoices.

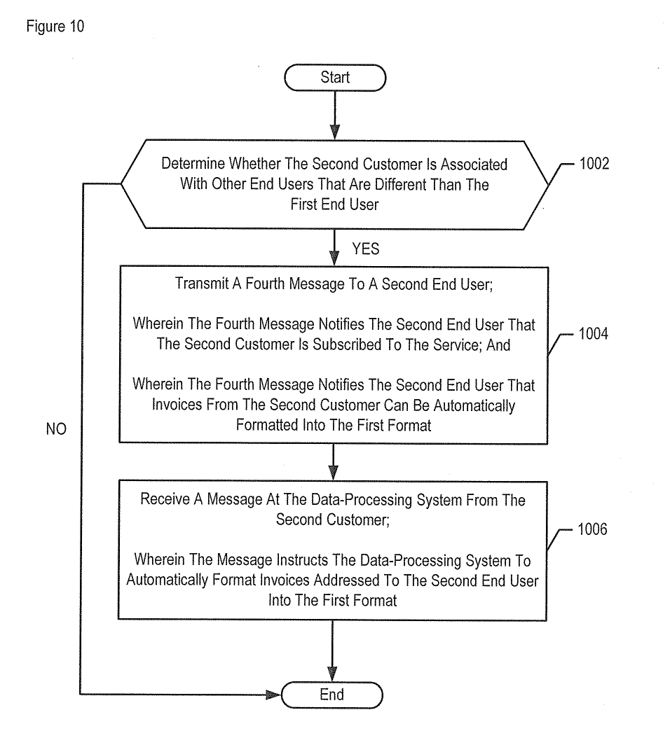

FIG. 10 depicts a flowchart of the salient tasks performed by an alternative embodiment of the present invention. It will be clear to those skilled in the art, after reading this disclosure, that tasks 1002 through task 1006 can be performed in any order without departing from the scope of the invention.

At task 1002, third-party data-processing system 112 performs a determination (i.e., a “second determination”). Specifically, the second determination is performed to establish whether second customer 108-2 is associated with other end users, such as the end user of terminal 104-2. In accordance with the illustrative embodiment, data-processing system 112 automatically and dynamically performs the second determination without receiving instructions to do so from any of the customers and end users. If data-processing system 112 determines that second customer 108-2 is not associated with any other end users, then the flow ends. On the other hand, if data-processing system 112 determines that second customer 108-2 is associated with another customer, then the flow moves to task 1004.

At task 1004, third-party data-processing system 112 transmits a message (i.e., a “fourth message”) to the end user of terminal 104-2. The fourth message notifies the end user of terminal 104-2 that second customer 108-2 is subscribed to the service for formatting correspondences in the first format. The fourth message also notifies the end user that invoices from second customer 108-2 can be automatically formatted into the first format, if desired. If the end user of terminal 104-2 desires to receive correspondences in the first format, an instruction is transmitted to second customer 108-2.

At task 1006, second customer 108-2 transmits a message (i.e., a “fifth message”) to data-processing system 112. In response to receiving the fifth message, data-processing system 112 updates memory 404. From this point on, when data-processing system 112 receives a correspondence from second customer 108-2 that is addressed to the end user of terminal 104-2, data-processing system 112 will know to send the correspondence to the end user in the first format.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, at a data-processing system, a first message from a first customer, wherein the first message notifies the data-processing system that a first end user desires to receive correspondences in a first format;
performing, by the data-processing system, a first determination to establish whether the first end user is associated with a second customer, wherein the second customer is different from the first customer;
transmitting, by the data-processing system, a second message to the second customer in response to the first determination, wherein the second message notifies the second customer that:
(i) the first end user desires to receive correspondences in the first format, and
(ii) a service is provided by the data-processing system that can satisfy the first end user's desire to receive correspondences in the first format; and
receiving, at the data-processing system, a third message from the second customer, wherein the third message subscribes the second customer to the service.

2. The method of claim 1, wherein the first determination is automatically performed by the data-processing system after receiving the first message; and
wherein the first determination is automatically performed by the data-processing system without receiving any instructions from the first customer and the first end user to perform the determination.

3. The method of claim 1 further comprising:
receiving, at the data-processing system, an invoice from the second customer;
performing, by the data-processing system, a second determination to establish whether the invoice is addressed to the first end user; and
automatically formatting, by the data-processing system, the invoice into the first format in response to the second determination.

4. The method of claim 3, wherein automatically formatting the invoice into the first format comprises:
extracting, by the data-processing system, at least one of the following items from a field of the invoice: an account number, an invoice number, an invoice date, a due date, and an amount due.

5. The method of claim 3, wherein the first format is an e-mail that lists at least one of the following items extracted from a field of the invoice: an account number, an invoice number, an invoice date, a due date, and an amount due; and
wherein the e-mail comprises a link, which when selected by the first end user, displays a graphical user interface that enables the first end user to electronically submit a payment for the amount due.

6. The method of claim 1 further comprising:
performing, by the data-processing system, a second determination to establish whether the second customer is associated with a second end user;
transmitting, by the data-processing system, a fourth message to the second end user in response to the second determination, wherein the fourth message notifies the second end user that:
(i) the second customer is subscribed to the service, and
(ii) invoices from the second customer can be automatically formatted into the first format.

7. The method of claim 6 further comprising:
receiving, at the data-processing system, a fifth message from the second customer, wherein the fifth message instructs the data-processing system to automatically format invoices addressed to the second end user into the first format.

8. The method of claim 1 further comprising:
performing, by the data-processing system, a second determination to establish whether there are other customers associated with the first end user, wherein the other customers are different from the first customer and the second customer; and
transmitting, by the data-processing system, the second message to the other customers in response to the second determination.

9. A method comprising:
receiving, at a data-processing system, a first message from a first customer, wherein the first message notifies the data-processing system that a first end user desires to receive correspondences in a first format;
performing, by the data-processing system, a first determination to establish whether the first end user is associated with a second customer, wherein the first determination is automatically performed by the data-processing system without receiving any instructions from the first customer and the first end user to perform the determination;
transmitting, by the data-processing system, a second message to the second customer in response to the first determination, wherein the second message notifies the second customer that:
(i) the first end user desires to receive correspondences in the first format, and
(ii) a service is provided by the data-processing system that can satisfy the first end user's desire to receive correspondences in the first format; and
receiving, at the data-processing system, a third message from the second customer, wherein the third message subscribes the second customer to the service.

10. The method of claim 9 further comprising:
performing, by the data-processing system, a second determination to establish whether there are other customers associated with the first end user, wherein the other customers are different from the first customer and the second customer; and
transmitting, by the data-processing system, the second message to the other customers in response to the second determination.

11. The method of claim 9 further comprising:
receiving, at the data-processing system, an invoice from the second customer;
performing, by the data-processing system, a second determination to establish whether the invoice is addressed to the first end user; and
automatically formatting, by the data-processing system, the invoice into the first format in response to the second determination.

12. The method of claim 11, wherein automatically formatting the invoice into the first format comprises:
extracting, by the data-processing system, at least one of the following items from a field of the invoice: an account number, an invoice number, an invoice date, a due date, and an amount due.

13. The method of claim 11, wherein the first format is an e-mail that lists at least one of the following items from a field of the invoice: an account number, an invoice number, an invoice date, a due date, and an amount due; and
wherein the e-mail comprises a link, which when selected by the first end user, displays a graphical user interface that enables the first end user to electronically submit a payment for the amount due.

14. A system comprising:
a first data-processing system associated with a first entity;
a second data-processing system associated with a second entity that is different from the first entity;
a third data-processing system associated with a third entity that is different from the first and second entities; and
a first end user associated with a fourth entity that is different from the first, second, and third entities;
wherein the first data-processing system is notified by the second data-processing system via a first message that the first end user desires to receive correspondences in a first format;
wherein the first data-processing system performs a first determination in response to receiving the first message in order to establish whether the first end user is associated with the third entity;
wherein the first data-processing system transmits a second message to the third data-processing system in response to the first determination, the second message notifying the third entity that:
(i) the first end user desires to receive correspondences in the first format, and
(ii) a service is provided by the first entity that can satisfy the first end user's desire to receive correspondences in the first format; and
wherein the first data-processing system receives a third message from the third data-processing system in response to the second message, the third message subscribing the third entity to the service.

15. The system of claim 14, wherein the first determination is automatically performed by the first data-processing system after receiving the first message; and
wherein the first determination is automatically performed by the first data-processing system without receiving any instructions from the second data-processing system and the first end user to perform the determination.

16. The method of claim 14, wherein the first data-processing system performs a second determination to establish whether there are any other entities associated with the first end user;
wherein the other entities are different from the first, second, and third entities; and
wherein first the data-processing system transmits the second message to the other entities in response to the second determination.
